(19) United States
(12) Patent Application Publication
(10) Pub. No.: US 2020/0187067 A1
(43) Pub. Date: Jun. 11, 2020

(54) CELL DISAMBIGUATION USING DEDICATED CELL-SPECIFIC MEASUREMENTS

(71) Applicant: NOKIA TECHNOLOGIES OY, Espoo (FI)

(72) Inventors: Guillaume Decarreau, Munich (DE); Irina-Mihaela Balan, Munich (DE); Ahmad Awada, Munich (DE); Stephen Mwanje, Dorfen (DE); Muhammad Naseer-Ul-Islam, Munich (DE); Ingo Viering, Munich (DE)

(21) Appl. No.: 16/637,734

(22) PCT Filed: Jul. 17, 2018
(86) PCT No.: PCT/EP2018/069379

§ 371 Date: Feb. 7, 2020

Related U.S. Application Data
(60) Provisional application No. 62/543,695, filed on Aug. 10, 2017.

(51) Int. Cl. H04W 36/00; H04W 24/10; H04L 5/00

(52) U.S. Cl. CPC H04W 36/0085; H04L 5/0048; H04W 24/10

(57) ABSTRACT

A user equipment transmits a measurement report to a serving base station. The measurement report includes a physical cell identifier (PCI) that is allocated to multiple neighbor base stations. The user equipment is configured to monitor a signal that is to be transmitted from at least one neighbor base station for cell-specific measurement by the user equipment. The user equipment is selectively handed over from the serving base station to one of the neighbor base stations dependent upon whether the user equipment detects its corresponding cell-specific measurement.

### BACKGROUND

A physical cell identifier (PCI) is used to identify each cell in a wireless communication system at the physical layer. The PCI for a cell is conveyed in a primary synchronization signal and a secondary synchronization signal that are transmitted or broadcast by the cell. There are a limited number of PCI values available to be allocated to cells. For example, in systems that operate according to the Long Term Evolution (LTE) standards defined by the Third Generation Partnership Project (3GPP), three different values of a primary synchronization sequence can be used to identify a cell number and 168 values of a secondary synchronization sequence can be used to indicate cell group numbers. The PCI for the cell can be defined as three times the cell group number plus the cell number, in which case there are 504 different values of the PCI that can be allocated to different cells. In some cases, the same PCI can be assigned to more than one cell in a particular geographic area, which can lead to collisions or confusion. A PCI collision occurs between two neighboring cells that transmit on the same frequency and use an identical PCI. A PCI confusion can occur between neighboring cells of a serving cell for a user equipment (UE) if more than one of the neighboring cells operate on the same frequency and are allocated the same PCI. If the serving cell receives a measurement report from a UE indicating a possible handover candidate cell with a PCI that is allocated to multiple neighboring cells, the serving cell has a confusion about which of the neighboring cells to contact for the handover. The PCI confusion may lead to UE handover failures or service drops.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a wireless communication system according to some embodiments.

FIG. 2 is a diagram of a wireless communication system configured to support directional communication using beamforming according to some embodiments.

FIG. 3 is a diagram of a wireless communication system that includes multiple base stations (gNB) configured to provide beamformed signals to user equipment in corresponding cells according to some embodiments.

FIG. 4 is a diagram of a message flow that is used to implement cell disambiguation using dedicated beam measurements according to some embodiments.

FIG. 5 is a block diagram of a communication system that implements cell disambiguation using dedicated beam measurements according to some embodiments.

### DETAILED DESCRIPTION

Physical cell identifier (PCI) confusion can be reduced or eliminated by configuring a base station that is serving a user equipment (UE) to transmit a request to a first base station that manages or controls a first neighboring cell in response to the serving base station receiving a measurement report from the UE that includes a PCI that is allocated to the first neighboring cell and to at least one second neighboring cell. The request instructs the first base station to perform a first-neighboring-cell-specific beam measurement operation with the UE. The serving base station can then select the first neighboring cell as a target cell for a handover of the UE in response to receiving a report from the UE indicating that the UE detected a cell-specific signal transmitted by the neighboring cell during the cell-specific beam measurement operation. In some embodiments, the first neighboring cell performs the cell-specific beam measurement operation by transmitting a reference signal such as a channel state information reference signal (CSI-RS). If the serving base station does not receive the first-neighboring-cell-specific beam measurement report from the UE, e.g., the report is not received within a predetermined time interval after the serving base station transmits the request, the serving base station determines that PCI confusion exists and the first neighboring cell is not selected as a target for handover of the UE.

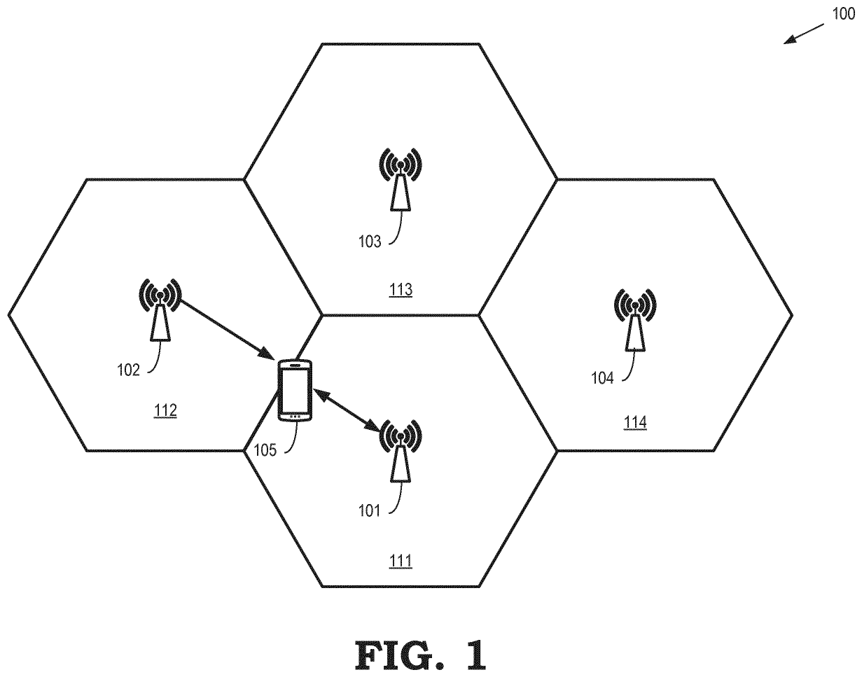

FIG. 1 is a block diagram of a wireless communication system 100 according to some embodiments. The wireless communication system 100 includes base stations 101, 102, 103, 104, which are collectively referred to herein as “the base stations 101-104.” The term “base station” is used to refer to entities that provide wireless connectivity within the wireless communication system 100 such as eNodeBs, base station routers, home base station routers, access points, metrocells, microcells, picocells, femtocells, and the like. In some cases, the terms “base station” and “cell” can be used interchangeably to refer to the entity that provides wireless connectivity within a corresponding geographical area. The base stations 101-104 provide wireless connectivity to corresponding geographical areas that are referred to as cells 111, 112, 113, 114, which are collectively referred to herein as “the cells 111-114.” For example, the serving base station 101 can provide wireless connectivity to a user equipment 105. The base stations 101-104 provide wireless connectivity according to correspond a wireless communication standards, such as Third Generation (3G), Fourth Generation (4G), Fifth Generation (5G), Wi-Fi, IEEE 802.11, and the like. For example, one or more of the base stations 101-104 can be implemented as a 5G gigabit NodeB (gNB) in accordance with standards defined by the Third Generation Partnership Project (3GPP).

Each of the base stations 101-104 maintains a neighboring-cell table (e.g., Table 1) that includes PCIs for a set of base stations and associated global cell identifiers (EGCIs). The neighboring cell table can also include the PCI and EGCI for the serving base station. The base stations 101-104 use the information in the neighboring-cell table to identify neighboring cells in measurement reports transmitted by the user equipment 105. For example, the user equipment 105 can transmit a measurement report including a value of an RSRP determined based on measurements of signals received from the base station 102 and a PCI for the base station 102. The serving base station 101 can use the measurement report to initiate a hand off to the base station indicated by the PCI in the measurement report. For example, the serving base station 101 can transmit a handoff command to the target base station 102. If the user equipment 105 reports a measurement for a neighboring base station or cell whose PCI is not listed in the neighboring cell table, the network (e.g., the serving base station 101 that received the measurement report) can send a request to the user equipment 105 to report the ECGI of the new neighboring cell, which can then establish an X2 interface to the network. The PCI and the ECGI can then be added to the neighboring cell table of the base station that received the measurement report, e.g., the serving base station 101. Although Table 1 includes the cell numbers, PCI, and ECGI for the neighboring cells 111-114, some embodiments of Table 1 do not include the cell number associated with the base station that is storing the Table 1. For example, if Table 1 is stored by the base station 101, the entry for cell number 111 may not be included in Table 1.

TABLE 1

| CELL NUMBER | PCI | ECGI |
|---|---|---|
| 111 | x | X |
| 112 | y | Y |
| 113 | z | Z |
| 114 | y | W |

The ECGI is a global identifier and so different values of the ECGI are allocated to the base station 102 and the base station 104. However, cell confusion arises because the base stations 102 and 104, as well as the corresponding cells 112 and 114, are allocated the same PCI values. The serving base station 101 is not able to distinguish between the base stations 102 and 104, or the corresponding cells 112 and 114, in the event that it receives a measurement report including the value of PCI=y. In some cases, the network can perform a reallocation of the PCI values to the base stations 101-104 to resolve the confusion. However, reallocation is a time-consuming operation and so the network may have to operate under conditions of cell confusion for a long time interval. Furthermore, PCI reallocation is not always possible because there is not always a PCI that is available (i.e., not assigned to another cell) to be allocated to resolve the confusion.

In the illustrated embodiment, if the user equipment 105 reports a PCI value of PCI=y to the base station 101 based on a measurement of a signal received from the base station 102, the base station 101 may misinterpret the received PCI value as referring to the base station 104, which also has a PCI value of PCI=y, and prepare for handover of the user equipment 105 to the base station 104. Consequently, the user equipment 105 hands over to the base station 102, but the network is prepared for handover of the user equipment 105 to the base station 104. The handover will therefore fail. In order to recover, the user equipment could perform re-establishment to the base station 102 or perform cell selection if the base station 102 did not have (or was unable to fetch) a context of the user equipment 105. Another way to resolve the PCI collision is to re-allocate a new PCI to either the base station 102 or the base station 104. However, as discussed above, PCI reallocation may not take effect immediately or may not be possible due to the limited PCI range. In that case, the network can send a request to the user equipment 105 to report the ECGI of the base station 102 by reading system information to resolve the ambiguity in the PCI values. The disadvantage to this approach is that the user equipment 105 reads the system information of the neighboring base station 102, which may take a long time, especially if the base station 102 belongs to a different frequency or radio access technology than that of the serving base station 101.

The base stations 101-104 can therefore be configured to perform cell disambiguation using dedicated cell-specific measurements. For example, the base station 101 is configured to receive measurement reports from the user equipment 105. The measurement reports include a physical cell identifier (PCI) that is allocated to more than one of the neighboring base stations 102-104. In response to receiving the measurement report, the base station 101 transmits a request to one or more of the neighboring base stations 102-104 to configure a cell-specific measurement for the user equipment 105. For example, the base station 101 can transmit a request to the base station 102 to transmit a cell-specific signal. The base station 101 can then selectively initiate handover of the user equipment 105 to one of the neighbor base stations 102-104 dependent upon whether the base station 101 receives a measurement report for the cell-specific measurement. For example, the base station 101 can initiate handover of the user equipment 105 to the base station 102 in response to receiving a measurement report indicating that the user equipment 105 detected the requested cell-specific signal transmitted by the base station 102. For another example, the base station 101 can bypass initiating handover of the user equipment 105 to the base station 102 if the base station 101 fails to receive a response indicating that the user equipment 105 detected the requested cell-specific signal transmitted by the base station 102. The cell-specific signal can be broadcast throughout the corresponding cell, e.g., substantially isotropically or uniformly within the cell, or the cell-specific signal can be spatially beamed into particular directions using beamforming techniques such as multiple-input-multiple-output (MIMO).

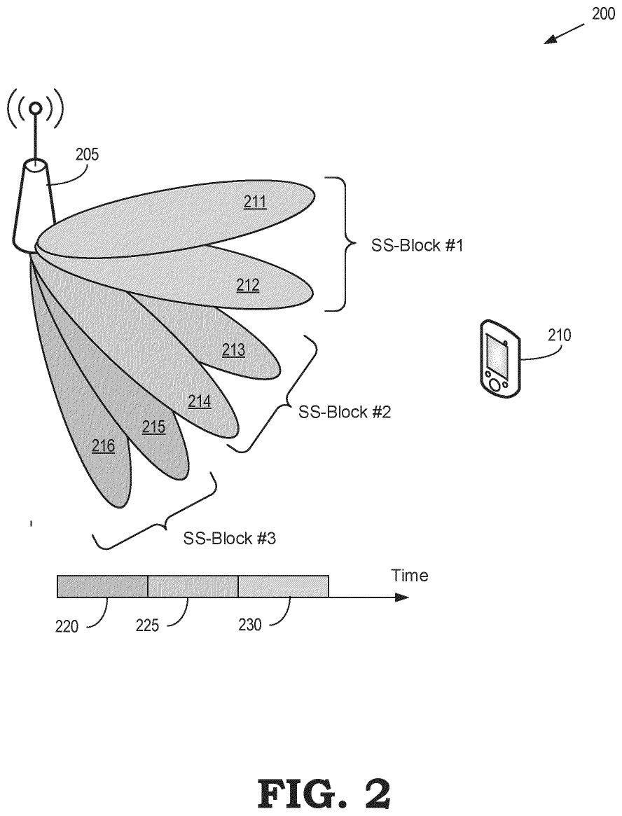

FIG. 2 is a diagram of a wireless communication system 200 configured to support directional communication using beamforming according to some embodiments. The wireless communication system 200 includes a base station 205 that can provide wireless connectivity to a user equipment 210 via beams 211, 212, 213, 214, 215, 216, which are referred to collectively herein as “the beams 211-216.” For example, the base station 205 can implement multiple antennas and utilize MIMO communication techniques. The multiple beams 211-216 can be used to provide coverage to a cell such as one of the cells 111-114 shown in FIG. 1. For example, multiple beams 211-216 can be used to cover a cell if the base station 205 operates according to 5G standards, which utilize high operating frequencies.

The base station 205 broadcasts PCI value(s) and a set of system information throughout the corresponding cell using beam sweeping, in which the beams 211-216 are used for transmission in successive time intervals. In the illustrated embodiment, the beams 211-216 are divided into groups (SS-Block #1, SS-Block #2, and SS-Block #3) and the base station 205 broadcasts the PCI value(s) and system information using the groups during corresponding time intervals. For example, the base station 205 broadcasts using the beams 215, 216 during the time interval 220, the base station 205 broadcasts using the beams 213, 214 during the time interval 225, and the base station broadcasts using the beams 211, 212 during the time interval 230.

The user equipment 210 is configured to monitor events based on a cell level quality metric (such as an RSRP) that can be determined or computed by the user equipment 210. In some embodiments, the cell level quality metric is computed using input from multiple individual be measurements. For example, the user equipment 210 can perform beam measurements during the time intervals 220, 225, 230. The user equipment 210 can therefore read the PCI value(s) from the beams 211-216. For another example, the user equipment 210 can perform individual measurements on specific beams. In that case, the user equipment 210 identifies the beam on the basis of a channel state information reference signal (CSI-RS). Each beam 211-216 has a different CSI-RS value and the user equipment 210 can be configured to identify the different CSI-RS values for the beams 211-216. Some embodiments of the user equipment 210 are configured to immediately perform the cell-specific measurement in response to receiving the information used to configure the cell-specific measurement. The user equipment 210 is also configured to provide an immediate response to the base station 205 to indicate whether or not the cell-specific measurement resulted in a significant value indicating detection of a cell-specific signal by the cell-specific measurement.

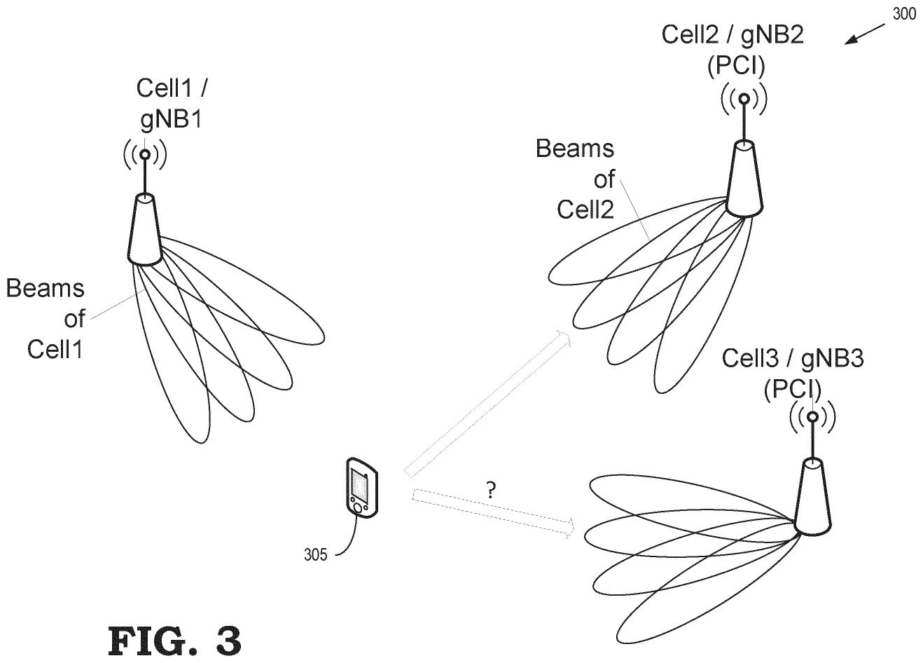

FIG. 3 is a diagram of a wireless communication system 300 that includes multiple base stations (gNB) configured to provide beamformed signals to user equipment 305 in corresponding cells according to some embodiments. When the user equipment 305 reports measurements associated with a PCI which correspond to more than one of the neighbouring cells, the serving gNB asks the possible neighbouring cell(s), having the same PCI, to set up beam measurement for the user equipment 305. The configurations for the beam measurements are cell-specific, e.g., the user equipment 305 can be configured to monitor CSI-RS values in the beams. If the user equipment 305 reports a beam measurement for a specific cell, e.g., if the report includes the CSI-RS value for the specific cell, the serving gNB can be sure that this cell is the right target cell of handover and can start the handover procedure to that cell.

The possible neighbouring cell(s) could be those from which the serving gNB has received a radio link failure (RLF) indication, e.g., indication that UEs have experienced an RLF with a serving gNB before reconnecting to a new neighbouring cell. In some cases, the cell specific measurements are not beam related, but only cell related. In some cases, the user equipment 305 sends a report to indicate that it has not detected the dedicated measurement, which could be done immediately after the configuration.

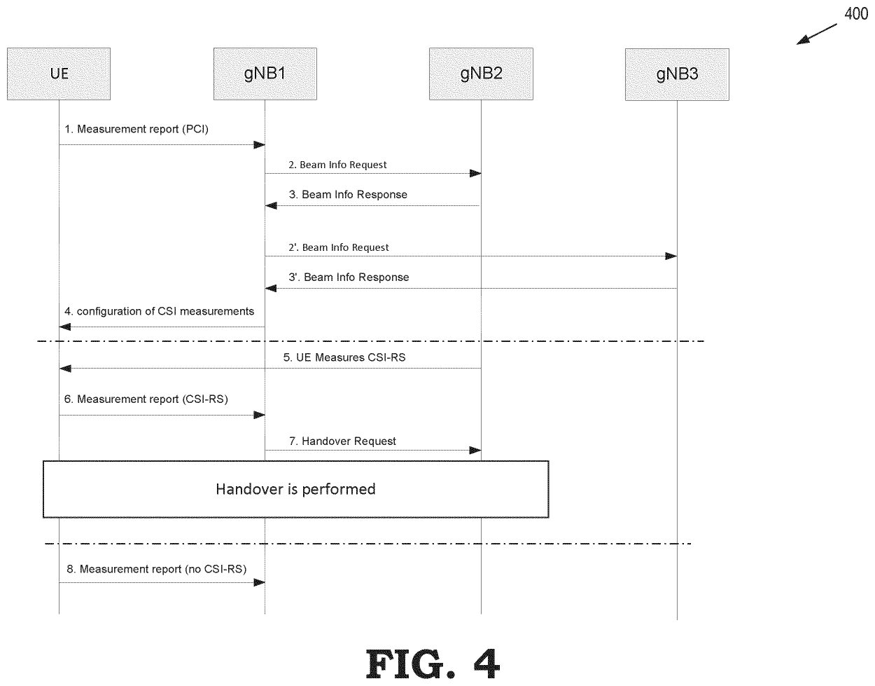

FIG. 4 is a diagram of a message flow 400 that is used to implement cell disambiguation using dedicated beam measurements according to some embodiments. The message flow 400 illustrates messages exchanged between user equipment (UE) and multiple base stations (gNB1, gNB2, and gNB3). The message flow 400 is therefore implemented in some embodiments of the wireless communication system 300 shown in FIG. 3.

At step 1, the UE reports a measurement on a cell identified with a specific PCI. The gNB1 associates the PCI with gNB2, but there is possibly another cell (Cell 3 controlled by gNB3) which uses the same PCI.

At step 2, the gNB1 transmits a request to gNB2 to configure dedicated CSI-RS measurements for the UE. The gNB1 can request that the gNB2 transmit using a large number of beams to increase the chances of detection by the UE.

At step 3, the gNB2 provides gNB1 with the configuration of CSI-RS measurements for Cell 2.

At step 2′, the gNB1 asks gNB3 to configure dedicated CSI-RS measurements for the UE. Step 2′ is an optional step that is not performed in all embodiments.

At step 3′, the gNB3 provides gNB1 with the configuration of CSI-RS measurements for Cell 3. Step 3′ is an optional step that is not performed in all embodiments.

At step 4, the gNB1 provides the UE with the configuration of CSI measurements pertaining to neighboring cell(s), e.g. cells 2 and 3.

In a first scenario, the UE has detected the configured CSI-RS measurement and the following steps are performed to handover the UE.

At step 5, the UE measures the configured CSI-RS on Cell 2.

At step 6, the UE reports the CSI-RS measurement to gNB1. This report could be triggered by an event such as detecting that a CSI-RS measurement level is above a given threshold. The report could also be triggered by a first discovery of the configured CSI-RS. The report could be triggered with/without applying measurement filtering. Step 6 could be performed several times, for example the first time can occur when the CSI-RS is first discovered, a second time when cell quality of the target cell is above a threshold. With this information, gNB1 knows for sure that UE was measuring Cell 2 and not Cell 3.

At step 7, the gNB1 begins the handover procedure to handover the UE from cell 1 to cell 2.

In a second scenario, the UE does not detect the CSI-RS and the following steps are performed.

At step 8, the UE sends a radio resource control (RRC) message to indicate that it has not detected the configured CSI-RS. The RRC message indicates for which CSI-RS this applies. This message could be sent for example at a given time after step 4 or immediately after the configuration. With this information, the gNB knows with more certitude if there was a mistake when identifying the target cell for handover. The indication of absence of CSI-RS detection could also be included in another measurement report message for example: an event triggered measurement based on SS-Block measurement.

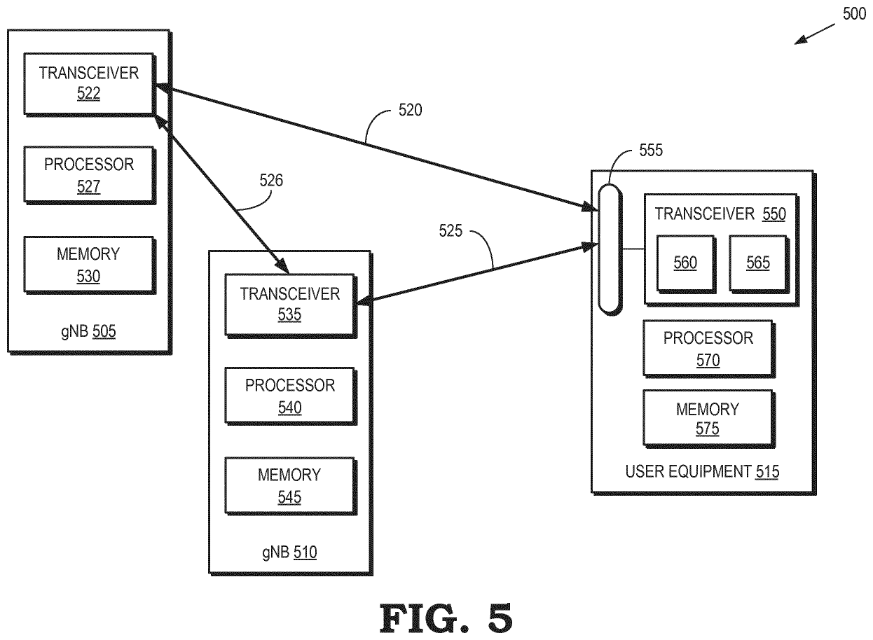

FIG. 5 is a block diagram of a communication system 500 that implements cell disambiguation using dedicated beam measurements according to some embodiments. The communication system 500 includes a first base station (gNB) 505, a second base station (gNB) 510, and a user equipment 515 that can communicate with the first base station 505 and the second base station 510 over a corresponding air interfaces 520, 525. The user equipment 515 can also handover between the first base station 505 and the second base station 510. The first base station 505 and the second base station 510 can communicate over an interface 526, such as an X2 interface. Some embodiments of the first base station 505, the second base station 510, and the user equipment 515 are configured to implement the message flow 400 illustrated in FIG. 4.

The base station 505 includes a transceiver 522 that is configured to support radio bearers over the air interface 520. The base station 505 also includes a processor 527 and a memory 530. The processor 527 can be used to execute instructions stored in the memory 530 and to store information in the memory 530 such as the results of the executed instructions.

The base station 510 includes a transceiver 535 that is configured to support radio bearers over the air interface 525. The base station 510 also includes a processor 540 and a memory 545. The processor 540 can be used to execute instructions stored in the memory 545 and to store information in the memory 545 such as the results of the executed instructions.

The user equipment 515 includes a transceiver 550 that is connected to an antenna 555 to transmit and receive signals over the air interfaces 520, 525. In the illustrated embodiment, the transceiver implements two or more radios 560, 565 that operate according to different radio access technologies. For example, the radios 560, 565 can be configured to support communication over the air interfaces 520, 525 if the base stations 505, 510 implement different radio access technologies. The user equipment 515 also includes a processor 570 and a memory 575. The processor 570 can be used to execute instructions stored in the memory 575 and to store information in the memory 575 such as the results of the executed instructions.

Embodiments of the techniques disclosed herein have a number of advantages over the conventional practice. For example, the UE doesn't need to read ECGI of the neighbor cell in order to resolve an ambiguity in PC's, which may take a long time in case of inter-frequency/inter-RAT neighboring cells. For another example, the UE uses existing mobility measurements to confirm that a specific neighboring cell is the right target cell of handover. For yet another example, the techniques disclosed herein allow multiple cells to continue to reuse the same PCI in the neighbor cell list (cell confusion) without taking action to re-allocate the PCI.

For reading the EGCI, the UE synchronizes first to the target cell (waiting time for Sync Signal is Xss), decodes PBCH (average waiting time is T_MIB/2, where T_MIB is the periodicity of MIB+UE decoding time, D, for the transport block), decodes SIB1 (average waiting time is T_SIB1/2 where T_SIB1 is the periodicity of SIB1+UE decoding time, D, for the transport block) and syncs back to source cell: (X_sync_back)

Total_time_1=Xss+T_MIB/2+T_SIB1/2+2D+X_sync_back

Using a method as described above, the UE measures the CSI-RS of the target cell. The UE syncs to the target cell (Xss), measures the CSI-RS (average waiting time is Tcsi/2+UE processing time D for channel estimation) and sync back to source cell (Xsync_back(

Total_time_2=Xss+T_csi/2+D+X_sync_back

The proposed scheme is faster than reading the EGCI if

Total_time_2<Total_time_1

Tcsi<T_MIB+T_SIB1+2D

If LTE values are taken as baseline for the NR, T_MIB=40 ms, T_SIB1=80 ms:

Tcsi<120ms+2D (1)

Equation (1) can be fulfilled by the target cell.

The proposal may also have advantages over e.g. multiple HO preparation, where the target cell performs admission control, reserves C-RNTI and configures the required resources according to the received E-RAB QoS information. In the proposed method, the target cell configures a CSI-RS and is not committed to any other additional resources like C-RNTI or resources according to the received E-RAB QoS information. From that perspective, the X2AP message sent by the source to the target cell for CSI-RS configuration may be less resource demanding than a X2AP Handover Request message.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1-15. (canceled)

16. A base station comprising:
a transceiver configured to receive, from a user equipment, a measurement report including a physical cell identifier (PCI) that is allocated to a plurality of neighbor base stations and transmit, to one of the plurality of neighbor base stations, a request to configure a cell-specific measurement with the user equipment; and
a processor configured to selectively initiate handover of the user equipment to the one of the plurality of neighbor base stations dependent upon whether the base station receives a measurement report for the cell-specific measurement.

17. The base station of claim 16, wherein the processor is configured to initiate the handover in response to the transceiver receiving the measurement report for the cell-specific measurement.

18. The base station of claim 16, wherein the processor is configured to bypass initiation of the handover if no measurement report for the cell-specific measurement is received.

19. The base station of claim 16, wherein the transceiver is configured to transmit a request to configure the user equipment to provide, immediately in response to the request, a response to the base station indicating whether or not the cell-specific measurement resulted in a value indicating detection of a cell-specific signal by the cell-specific measurement.

20. The base station of claim 16, wherein the transceiver is configured to transmit a request to configure the cell-specific measurement using a channel state information reference signal (CSI-RS) associated with a signal transmitted by the one of the plurality of neighbor base stations.

21. The base station of claim 20, wherein the transceiver is configured to transmit a request to the one of the plurality of neighbor base stations to transmit a cell-specific signal that is spatially beamformed in a particular direction.

22. The base station of claim 20, wherein:
the transceiver is configured to receive a measurement report including the CSI-RS; and
the processor is configured to initiate handover of the user equipment to the one of the plurality of neighbor base stations in response to receiving the measurement report including the CSI-RS.

23. A user equipment comprising:
a transceiver configured to transmit, to a base station, a measurement report including a physical cell identifier (PCI) that is allocated to a neighbor base station; and
a processor configured to configure the user equipment to monitor signals for a cell-specific measurement and selectively hand over the user equipment from the base station to the neighbor base station dependent upon whether the user equipment detects the cell-specific measurement.

24. The user equipment of claim 23, wherein the processor is configured to hand over the user equipment in response to the user equipment detecting the cell-specific measurement in signals transmitted by the neighbor base station.

25. The user equipment of claim 23 or 211, wherein the processor is configured to bypass handover of the user equipment in response to the user equipment failing to detect the cell-specific measurement.

26. The user equipment of claim 23, wherein the transceiver is configured to provide, immediately in response to receiving a request to configure the user equipment to monitor the signals for the cell-specific measurement, a response to the base station to indicate whether or not the cell-specific measurement resulted in a value indicating detection of a cell-specific signal by the cell-specific measurement.

27. The user equipment of claim 23, wherein the processor is configured to configure the user equipment to monitor signals for the cell-specific measurement using a channel state information reference signal (CSI-RS) transmitted by the one of the plurality of neighbor base stations.

28. The user equipment of claim 27, wherein the processor is configured to:
detect the CSI-RS in the cell-specific measurement; and
hand over the user equipment from the base station to the neighbor base station in response to detecting the CSI-RS.

29. A first base station comprising:
a transceiver configured to receive, from a second base station, a request to perform a cell-specific measurement with a user equipment in response to the second base station receiving a measurement report from the user equipment including a physical cell identifier (PCI) that is allocated to the first base station and at least one third base station; and
a processor to configure the first base station to perform a cell-specific measurement with the user equipment in response to receiving the request, wherein the transceiver is configured to transmit the cell-specific signal in response to receiving the request.

30. The first base station of claim 29, wherein the transceiver is configured to receive a request to perform the cell-specific measurement using a channel state information reference signal (CSI-RS) and transmit the cell-specific signal including the CSI-RS, and wherein the processor is to configure the first base station to perform the cell-specific measurement on the basis of the CSI-RS.

31-33. (canceled)
